(19) United States
(12) Patent Application Publication
(10) Pub. No.: US 2006/0131915 A1
(43) Pub. Date: Jun. 22, 2006

(54) Pinch detection device and opening/closing device

(75) Inventors: Hiroyuki Ogino, Nara-shi (JP); Shigeki Ueda, Yamatokohriyama-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/541,580

(22) PCT Filed: Jan. 16, 2004
(86) PCT No.: PCT/JP04/00325

§ 371 Date: Jul. 6, 2005

(30) Foreign Application Priority Data
Jan. 16, 2003 (JP) 2003-007996

(51) Int. Cl. B62D 25/10

(52) U.S. Cl. 296/76; 49/31

(57) ABSTRACT

A pinching detection apparatus having a pressure sensor 2 disposed along the geometry of a trunk lid 1 in a flexible manner, and determination means 16 for detecting that an object is being pinched between a body opening section 7 and the trunk lid 1, in accordance with a signal output from the pressure sensor 2. Since the pressure sensor 2 is disposed along the geometry of the trunk lid 1 in a flexible manner, pinching by the trunk lid 1 can be detected.

### FIELD OF THE INVENTION

The present invention relates to a pinching detection apparatus which detects that an object is being pinched between a body opening section of a vehicle, such as an automobile, and a trunk lid, as well as to an opening/closing apparatus.

### BACKGROUND TECHNIQUE

A related-art pinching detection apparatus has a motor-driven trunk lid and indirectly detects that an object is being pinched between a body opening section and the trunk lid, on the basis of a change in the driven state of the motor which arises when the object has been pinched between the body opening section and the trunk lid (see, e.g., “Introduction of State-of-the-Art Embedded in E65, No. 1, Exterior,” May 7^{th}, 2002, http://www.bohp.net/html/event91.htm).].”

However, according to the above-described related-art configuration, occurrence of pinching is detected on the basis of a change in a driven state of a motor; e.g., a change in a drive current supplied to the motor. For this reason, there is no alternative but to increase a threshold for detecting pinching so as to prevent occurrence of erroneous detection of pinching, which would otherwise be caused by an increase in drive resistance, such as squeaking of a drive mechanism attributable to age-related deterioration, or the like.

Therefore, when an object is actually being pinched, the load exerted on the object becomes larger, thereby raising a problem of increasing the chance of inflicting damage on the pinched object.

Moreover, during closing operation of the trunk lid, greater rotational torque acts on an area close to a rotary shaft of the trunk lid as compared with the rearmost portion of the trunk lid. Hence, there arises a problem of greater damage being inflicted on an object when the object is caught between the body opening section and the trunk lid close to the rotary shaft of the trunk lid than when the object is caught at the rearmost portion of the trunk lid.

### DISCLOSURE OF THE INVENTION

In order to solve the problem, the present invention is provided with a pressure sensor disposed along an outer edge of a trunk lid of a vehicle, and determination means for detecting an object being pinched between a body opening section of the automobile and the trunk lid, on the basis of a signal output from the pressure sensor. Pinching caused by the trunk lid can be detected by means of the pressure sensor.

To solve the problem, the present invention enables detection of pinching caused by the trunk lid, by means of the pressure sensor disposed along the outer edge of the trunk lid.

The pressure sensor has a flexible piezoelectric sensor. Under a situation where a contact-type pressure-sensitive switch comprising a plurality of mutually-opposing electrodes is used as the pressure sensor and disposed along the trunk lid, if the trunk lid has a bent section, the electrodes contact each other at that bent section, thereby causing erroneous detection. In contrast, the piezoelectric sensor has no contacts. Even when the piezoelectric sensor is disposed along bent areas, the sensor can detect occurrence of pinching without involvement of occurrence of a detection error, whereby enhanced reliability is achieved.

The pressure sensor has a nonlinear flexible member whose displacement in response to load is nonlinear. The piezoelectric sensor is disposed adjacent to the nonlinear flexible member. For instance, even when an object is pinched when the closing speed of the trunk lid is slow, the nonlinear flexible member is quickly deformed as a result of the pressing load exerted on the pressure sensor by the object having reached a predetermined value or more, and the adjacently-disposed piezoelectric sensors also undergo sudden deformation, thereby outputting a large output signal. As a result, occurrence of pinching can be determined by the determination means, and reliability concerning detection of pinch is greatly enhanced.

The determination means determines whether or not the object maintains contact with the object, on the basis of the signal output from the piezoelectric sensor. For instance, when the object is determined to maintain contact with the piezoelectric sensor, control for inhibiting closing of the trunk lid becomes feasible, thereby resulting in enhanced reliability.

The pressure sensor has a cushioning section which can be compressed by the pressure stemming from the pinched object. Even when occurrence of pinching has been detected, the cushioning section is compressed until movement of the trunk lid is reversely moved. Therefore, an increase in pinching load applied to the object can be prevented, to thus diminish stress or damage inflicted on the pinched object.

Moreover, the present invention further comprises the above-described pinching detection apparatus, drive means for driving the trunk lid, and control means for controlling the drive means so as to release pinching when pinching is determined to have arisen on the basis of the signal output from the determination means. Pinching is released when pinching is determined to have arisen, and hence occurrence of unwanted pinching can be prevented.

When the trunk lid is closed, the drive means is controlled such that the trunk lid is closed after the trunk lid has once been moved over a predetermined distance in an opening direction. Even when the object has come into contact with the piezoelectric sensor before the trunk lid starts closing, the trunk lid is closed after having once been moved over a predetermined distance in an opening direction. The inertial force of the object having moved in the opening direction is applied to the piezoelectric sensor by means of the closing action, thereby reliably pressing the piezoelectric sensor. Therefore, occurrence of pinching can be reliably detected.

### BRIEF DESCRIPTION OF THE DRAWINGS

FIG. 1(a) is an external view of a pinching detection apparatus and an opening/closing apparatus, both belonging to a vehicle, according to an invention of a first embodiment when the pieces of the apparatus are viewed in the lateral direction of the vehicle;

FIG. 1(b) is an external view of the apparatus when viewed from the rear of the vehicle;

FIG. 2(a) is an external view of a case where a pressure sensor is provided on either side of the trunk lid;

FIG. 2(b) is an external view of a case where a single pressure sensor is disposed along both sides and a lower edge of the trunk lid;

FIG. 3(a) is a cross-sectional block diagram taken along line A-A in FIG. 1 when the trunk lid is closed;

FIG. 3(b) is a cross-sectional block diagram taken along line A-A shown in FIG. 1(a) while an object is pinched between the trunk lid and an opening section of the body;

FIG. 4 is an external view of a pressure sensor of the apparatus;

FIG. 5 is a block diagram of the apparatus;

FIG. 6 is a characteristic plot showing a signal V output from a filtering section of the apparatus, a determination output produced by a pinch determination section, and a voltage Vm applied to a motor;

FIG. 7(a) is a cross-sectional profile of a pinching detection apparatus and a pressure sensor of an opening/closing apparatus, both pertaining to an invention of a second embodiment (showing that no load is applied to the pressure sensor);

FIG. 7(b) is a cross-sectional profile of the pinching detection apparatus and the pressure sensor of the opening/closing apparatus, both pertaining to the invention of the second embodiment (showing that a predetermined load or more is applied to the pressure sensor, and the pressure sensor is compressed);

FIG. 8 is a characteristic plot showing a signal V output from a filtering section of a pinching detection apparatus and an opening/closing apparatus, both pertaining to an invention of a third embodiment, and a determination J output from a pinch determination section of the same apparatus; and

FIG. 9 is a characteristic view showing a voltage Vm applied to a drive means belonging to a pinching detection apparatus and an opening/closing apparatus according to an invention of a fourth embodiment.

### BEST MODES FOR IMPLEMENTING THE INVENTION

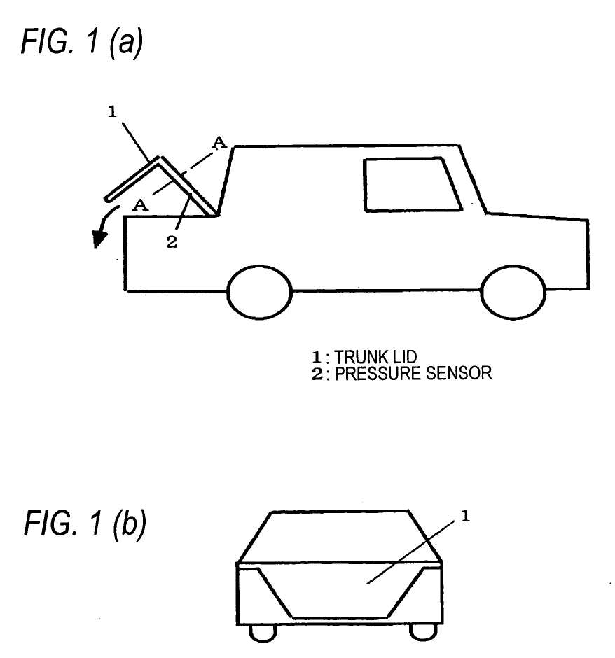

Embodiments of the present invention will be hereinbelow described by reference to FIGS. 1 to 9.

### First Embodiment

An invention of a first embodiment will be described by reference to FIGS. 1(a) to 6.

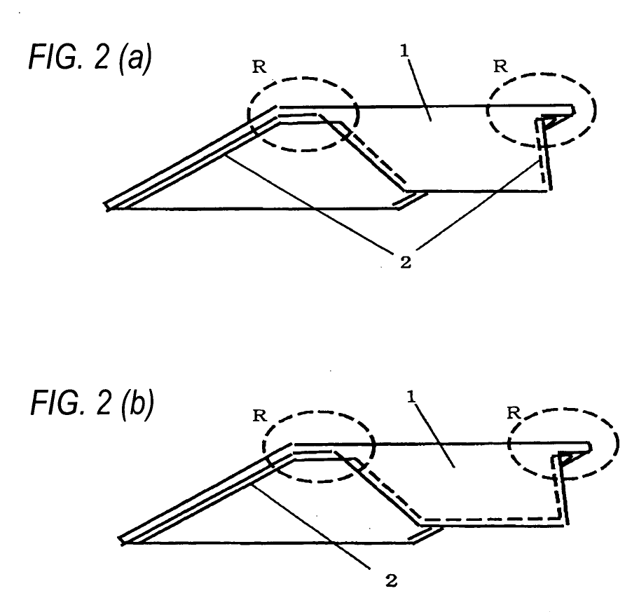

FIG. 1(a) is an external view of a pinching detection apparatus and an opening/closing apparatus of the invention of the first embodiment as viewed from a lateral direction of a vehicle body (showing a state where a trunk lid is open), and FIG. 1(b) is an external view of the same as viewed from the rear of the vehicle body (showing a state where the trunk lid is closed), both views showing a configuration where a pressure sensor 2 is disposed on a trunk lid 1 of a vehicle is shown. FIG. 2 is external views showing a placement location of the pressure sensor 2 on the trunk lid 1, where the trunk lid 1 is viewed from the interior of the vehicle. FIG. 2(a) shows a state where the pressure sensor 2 is disposed on each of right and left sides of the trunk lid 1, and FIG. 2(b) shows a state where a single pressure sensor 2 is disposed along both the right and left sides and a lower end of the trunk lid 1.

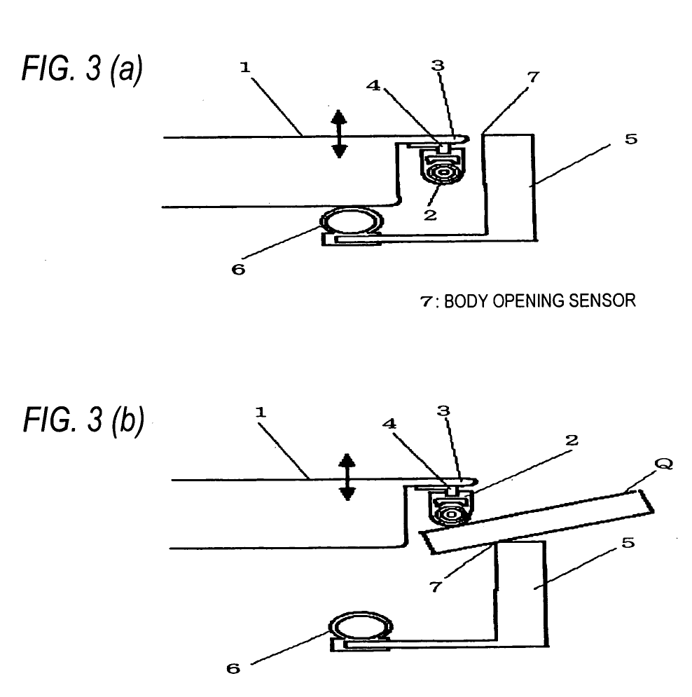

FIGS. 3(a) and 3(b) are cross-sectional views showing the configuration as viewed along line A-A of FIGS. 1. The upper side of the drawings indicates an inside of a vehicle compartment; and the lower side indicates an outside of the vehicle. FIG. 3(a) shows a state where the trunk lid 1 is closed and the pressure sensor 2 is disposed at an end section 3 of the trunk lid 1 by way of support means 4. Reference numeral 5 denotes a vehicle body; and reference numeral 6 denotes a seal section which seals a gap between a body opening 7 and a body 5, and the trunk lid 1 when the trunk lid 1 is closed. The pressure sensor 2 is fixed to the end section 3 with a clearance of a predetermined distance from the body 5 so as not to come into contact with the body 5 when the trunk lid 1 is completely closed. In consideration of the possibility of pinching of a finger of a child or the like, this distance is preferably set to 3 to 5 mm. FIG. 3(b) is a cross-sectional view showing the configuration as viewed along the line A-A of FIGS. 1, showing a state where an object Q is pinched between the trunk lid 1 and the body opening 7.

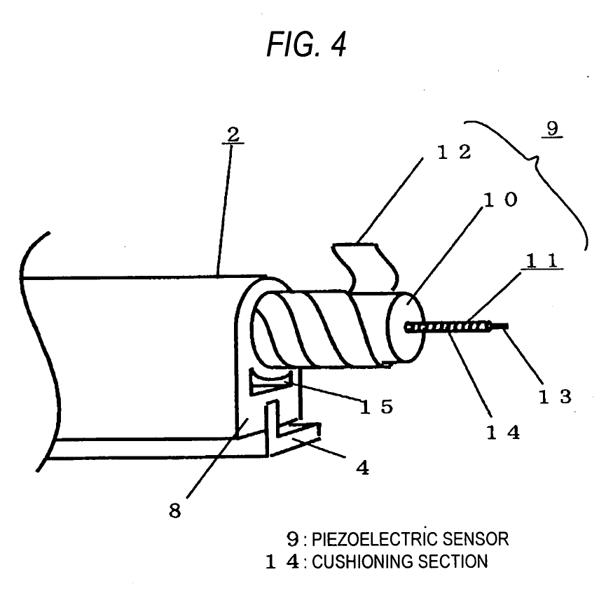

FIG. 4 is a view showing the configuration of the pressure sensor 2. As shown in FIG. 4, the pressure sensor 2 is configured such that a flexible, piezoelectric sensor 9 is disposed in an elastic member 8. The piezoelectric sensor 9 has a coaxial cable-like configuration which is formed by means of concentrically stacking a composite piezoelectric layer 10 serving as a piezoelectric material, and a center electrode 11 and an external electrode 12 serving as electrodes which sandwich the composite piezoelectric layer 10, whereby the pressure sensor 2 is configured so as to have excellent flexibility as a whole. The piezoelectric sensor 9 is manufactured through the following process. First, a chlorinated polyethylene sheet and piezoelectric ceramic powder (in the embodiment, lead titanic acid zirconate) in an amount of 40 to 70 vol % (volume%) are uniformly mixed into a sheet by means of a rolling method. The sheet is cut into fine pellets, and these pellets are continuously extruded in conjunction with the center electrode 11, thereby forming the composite piezoelectric layer 10. The external electrode 12 is wound around the composite piezoelectric layer 10. The elastic member 8 surrounding the external electrode 12 is also extruded continuously. Finally, for the purpose of polarizing the composite piezoelectric layer 10, high, direct-current voltage of 5 to 10 kV/mm is applied between the center electrode 11 and the external electrode 12.

Prior to addition of the piezoelectric ceramic powder to the chlorinated polyethylene, the piezoelectric ceramic powder is preferably immersed in a solution of titanium coupling agent, and dried. Through this treatment, the surface of the piezoelectric ceramic powder is covered with a hydrophilic group and a hydrophobic group, which are contained in the titanium coupling agent. The hydrophilic group prevents aggregation of the piezoelectric ceramic powder; and the hydrophobic group increases wettability between the chlorinated polyethylene and the piezoelectric ceramic powder. As a result, the piezoelectric ceramic powder can be uniformly added in the chlorinated polyethylene with a high content of up to 70 vol %. It is found that the same effect as above can be obtained when the titanium coupling agent is added during the course of rolling of the chlorinated polyethylene and the piezoelectric ceramic powder in place of immersion in the titanium coupling agent solution. This treatment is excellent in that no particular immersion treatment in a titanium coupling agent solution is required.

An ordinary metal single lead wire may be employed as the center electrode 11; however, in the embodiment, such an electrode that a metal coil 14 is wound around an insulating polymer fiber 13 is employed. As the insulating polymer fiber 13 and the metal coil 14, a polyester fiber and a copper alloy containing 5 wt % of silver are preferably employed.

The external electrode 12 is configured such that a strip electrode, constructed by means of affixing a metal film to a polymer layer, is wound around the composite piezoelectric layer 10. An electrode, which uses polyethylene terephthalate (PET) as the polymer layer, and on which an aluminum film is affixed, is preferable as the external electrode 12, because such an electrode has high thermal stability at 120° C. and is commercially mass-produced. Meanwhile, for the purpose of shielding the piezoelectric sensor 9 from electrical noise of the external environment, the external electrode 12 is preferably wound around the composite piezoelectric layer 10 in such a manner as to partially overlap itself

An elastic material, such as rubber, of higher flexibility and elasticity than the piezoelectric sensor 9 is employed as the elastic member 8 so that the piezoelectric sensor 9 easily deforms under pressure applied as a result of pinching of an object in consideration of heat resistance and cold resistance in view of an in-vehicle component; specifically, a material which exhibits a small degree of degradation in flexibility at −30 to 85° C. is preferably selected. For instance, ethylene propylene rubber (EPDM), chloroprene rubber (CR), butyl rubber (IIR), silicone rubber (Si), or a thermoplastic elastomer may be used as such rubber. In addition, the elastic member 8 has a cushioning section 15 which is formed so as to have a hollow space and which can be compressed under pressure applied by a pinched object. Furthermore, a groove for enabling fixed support by the support means 4 is formed in the bottom of the elastic member 8.

When the pressure sensor 2 is attached to the trunk lid 1, first, the support means 4 is formed so as to allow attachment along the end section of the trunk lid 1; and the pressure sensor 2 is fixed to the thus-formed support means 4. Subsequently, a sensor member constituted of the pressure sensor 2 and the support means 4 is attached to the end section of the trunk lid 1. As a method of fixing, for instance, fastening to a fixation hole formed on the support means 4 by means of a screw may be employed.

In a case where a contact-type pressure switch constituted of a plurality of opposing electrodes is employed as the pressure sensor 2 and disposed on the trunk lid 1, when the trunk lid 1 includes a bent section, the electrodes are brought into contact with each other at the bent section, and cause erroneous detection. However, since the piezoelectric sensor 8 has no contact, even when the sensor 8 is disposed at a bent section, an erroneous detection does not occur. Therefore, in the first embodiment, by virtue of the above-mentioned configuration, even when the trunk lid 1 includes a bent section R as shown in FIGS. 2, the pressure sensor 2 can be disposed along the bent section R.

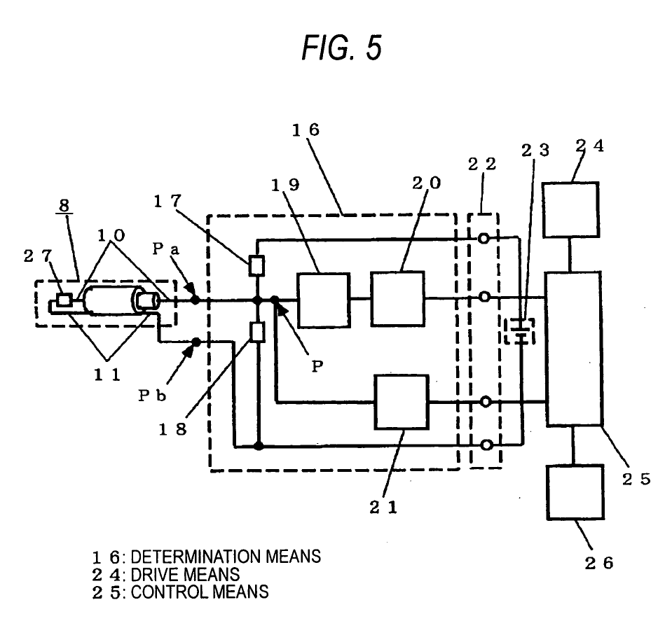

FIG. 5 is a block diagram of the pinching detection apparatus and the opening/closing apparatus of the invention of the first embodiment. As shown in FIG. 5, reference numeral 16 denotes determination means; 17 denotes a circuit-side resistor for detecting disconnection; 18 denotes a signal lead-through resistor for leading signals output from the piezoelectric sensor 8; 19 denotes a filter section which allows passage of only predetermined frequency components of an output signal from the piezoelectric sensor 8; 20 denotes a determination section for determining occurrence of pinching on the basis of the output signal from the filter section 19; 21 denotes an anomalous condition determination section for determining an anomaly such as malfunction of the piezoelectric sensor 8; 22 denotes a connector; 23 denotes a battery; 24 denotes drive means for driving the trunk lid 1; 25 denotes control means for controlling the drive means 24 on the basis of an output signal from the determination means 16; and 26 denotes a display section for displaying, on a front panel in a vehicle compartment or the like, a result of determination by the determination means 16. For instance, an electric motor is employed as the drive means 24. Reference numeral 27 denotes a sensor-side resistor which is disposed, as a resistor for detecting disconnection, between the center electrode 10 and the external electrode 11 at an end section of the piezoelectric sensor 8.

The filter section 19 has such filtering characteristics as to reject unwanted signals derived from vibrations of a vehicle body, and the like, from the output signal of the piezoelectric sensor 8, to thus extract signals having frequency components which are characteristic to pinching of an object. The filtering characteristic may be determined so as to be optimized in consideration of vibration characteristics of the vehicle body, and the like. More specifically, for the purpose of eliminating vibrations generated by a vehicle engine and running, the filter section is preferably embodied as a low pass filter which extracts signal components of about 10 Hz or lower.

The piezoelectric sensor 8 and the determination means 16 are directly connected; and the determination means 16 is disposed on an upper end of the trunk lid 1, or incorporated in the same. For the purpose of eliminating external electrical noise, the entire determination means 16 is preferably covered by a shielding member and electrically shielded. Alternatively, a lead-through capacitor or an EMI filter may be added to an input/output section of the determination means 16 as a countermeasure against a strong electric field.

Next, operations will be described. As shown in FIG. 3(b), when the object Q is pinched between the trunk lid 1 and the body opening 7, the object Q is brought into contact with the pressure sensor 2. Pressure applied from the object Q deforms the piezoelectric sensor 8 in the pressure sensor 2.

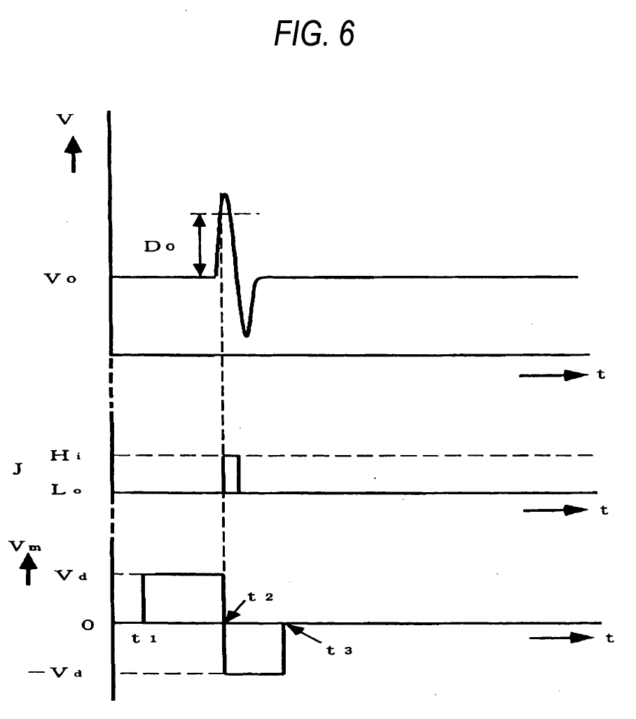

FIG. 6 is a characteristic diagram for this case showing an output signal V of the filter section 19, a determination output J of the pinch determination section 20, and an applied voltage Vm applied to the drive means 24. In FIG. 6, V, J, and Vm are plotted on the Y axis, in this order from the top; and time “t” is plotted on the X axis. At time t1, a voltage of +Vd is applied, to thus drive the trunk lid 1 in a closing direction. When pinching occurs, the piezoelectric sensor 8 outputs a signal (a signal component larger than a reference voltage V0 in V of FIG. 6) in accordance with an acceleration of deformation of the piezoelectric sensor 8 by the piezoelectric effect. When V-V0, which is an amplitude of V from V0, is DO or greater, the pinch determination section 20 determines that pinching has occurred, and outputs a pulse signal of Lo→Hi→Lo as a determination output at time t0. Upon receipt of this pulse signal, the control means 25 stops application of the voltage of +Vd to the drive means 24, causes the display section 26 to display an indication of occurrence of pinching, and applies a voltage of −Vd for a predetermined period of time to thus drive the trunk lid 1 in an opening direction, thereby releasing the pinching. There may be employed such a configuration that the display section 26 raises an alarm when a determination as to occurrence of pinching is made. When pinching is released, the piezoelectric sensor 8 outputs a signal (a signal component smaller than the reference voltage V0 of FIG. 6) in accordance with an acceleration of recovery from deformation.

Meanwhile, in the event of occurrence of pinching, whether V becomes greater than V0 or smaller than V0 changes according to a bending direction of the piezoelectric sensor 8, a polarization direction of the same, allocation of the electrodes (as to which one of the electrodes is taken as the reference voltage), and a supporting direction of the piezoelectric sensor 8. Therefore, there may be employed a configuration such that the pinch determination section 20 determines occurrence of pinching on the basis of |V−V0|, which is an amplitude of V from V0, thereby enabling making of a determination as to occurrence of pinching regardless of whether or not V is greater than V0.

Meanwhile, since the elastic body 8 has the cushioning section 15 which can be compressed under pressure applied from a pinched object, when the object Q is pinched, the cushioning section 15 is compressed after the determination section 16 detects pinching until the trunk lid 1 is reversely activated; accordingly, the cushioning section 15 suppresses an increase in the pinching load applied on the object Q, thereby reducing stress or damage applied to the pinched object Q. In addition, since the cushioning section 15 is collapsed, the degree of deformation of the piezoelectric sensor 8 is increased, and the output signal from the piezoelectric sensor 9 is increased, detection of pinching is facilitated.

Next, a procedure for determining occurrence of disconnection by means of the anomalous condition determination section 21 will be described hereinbelow. In FIG. 5, the resistance value of the sensor-side resistor 27, that of the circuit-side resistor 17, and that of the signal lead-through resistor 18 are respectively assumed to be R1, R2, and R3; a voltage at a point P is assumed to be Vp; and a voltage of a power source 23 is assumed to be Vs. Resistance values of several to tens of megohms are usually employed as R1, R2, and R3. When the electrode of the piezoelectric sensor 8 is normal, Vp assumes the value of a divided voltage determined by R1 and the resistance values of R2 and R3 in parallel, with respect to Vs. Since the resistance value of the composite piezoelectric layer 10 is usually hundreds of megohms or larger, the resistance value contributes little to the resistance values of R2 and R3 in parallel and, hence, is neglected in calculation of the divided voltage value. When the electrode of the piezoelectric sensor 8 is broken, the point Pa or Pb is equivalently opened, and hence Vp assumes the divided voltage value determined by R2 and R3. When a short circuit has arisen in the electrode, the points Pa and Pb are equivalently short-circuited, and therefore Vp becomes equal to Vs. As described above, since the anomalous condition determination section 21 detects an anomalous condition, such as disconnection or a short circuit, of the electrodes of the piezoelectric sensor 8 on the basis of the value of Vp, enhanced reliability can be achieved.

Since a pressure sensor is disposed along the periphery of a trunk lid of a vehicle, pinching by the trunk lid can be directly detected by the pressure sensor through the above-described operations.

In addition, in a case where a pressure sensor includes a flexible piezoelectric sensor, and a contact-type pressure switch constituted of a plurality of opposing electrodes is employed as the pressure sensor and disposed on the trunk lid, when the trunk lid includes a bent section, the electrodes are brought into contact with each other at the bent section to thus cause erroneous detection; however, since a piezoelectric sensor has no contact, even when the piezoelectric sensor is disposed on a bent section, pinching can be detected without involvement of erroneous detection, whereby enhanced reliability can be achieved while the degree of freedom in design of the trunk lid is improved.

In addition, the pressure sensor has the cushioning section which can be compressed by the pressure exerted by a pinched object. Even when occurrence of pinching is detected, the cushioning section is compressed until the trunk lid is reversely moved, an increase in the pinching load exerted on the object can be suppressed, whereby stress or damage inflicted on the pinched object Q can be reduced.

Furthermore, a pinching detection apparatus employing a pressure sensor and drive means for driving the trunk lid are provided, and control means which controls the drive means so as to release pinching when occurrence of pinching is determined on the basis of an output signal from the determination means is also provided. Accordingly, an opening/closing apparatus for preventing undesired pinching can be provided.

Meanwhile, the piezoelectric sensor 8 of the present invention has the composite piezoelectric layer 10 constituted of a mixed composition containing chlorinated polyethylene and piezoelectric ceramic powder; and the composite piezoelectric layer 10, having both advantages of flexibility pertaining to chlorinated polyethylene and high thermal stability pertaining to the piezoelectric ceramic, can operate for 1,000 hours or longer at 120° C. In addition, the piezoelectric sensor 8 of the present invention obviates a necessity for vulcanization processing, which is required for manufacturing general synthetic rubber.

### Second Embodiment

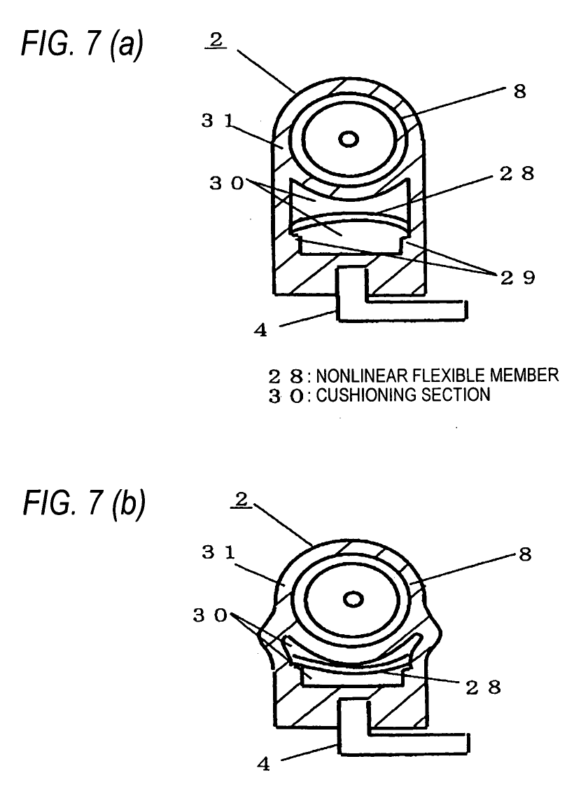

An invention of a second embodiment will be described by reference to FIGS. 7(a) and 7(b). FIGS. 7(a) and 7(b) show cross-sectional views of the pressure sensor 2 of a pinching detection apparatus and the invention of the second embodiment; where FIG. 7(a) shows a state where a predetermined load is not applied on the pressure sensor 2, and FIG. 7(b) shows a state where a load of predetermined value or greater is applied, thereby compressing the pressure sensor 2.

The second embodiment differs from the first embodiment in that the pressure sensor 2 includes a nonlinear flexible member 8 whose deflection in relation to a load is nonlinear, and in that the piezoelectric sensor 8 is disposed adjacent to the nonlinear flexible member 28. As the nonlinear flexible member 28, there is used, for instance, a strip thin steel or reinforced resin of a convex shape as employed in a convex gage. Such a member has a characteristic of being abruptly deformed concavely when pressing load is increased to a predetermined value or greater and recovering to its original shape when application of the load is stopped. Meanwhile, in FIG. 7(a) and 7(b), reference numeral 29 denotes a support member for supporting the nonlinear flexible member 28; 30 denotes a cushioning section; and 31 denotes an elastic member of the same material as that of the first embodiment.

In the configuration of the first embodiment, since, when a load is applied slowly to the pressure sensor 2, the piezoelectric sensor 8 deforms slowly, the signal output from the piezoelectric sensor 8 becomes small, thereby, in some cases, causing a failure in pinch determination.

In contrast, in the second embodiment, according to the above configuration, when an object is pinched, e.g., during a period in which a closing speed of the trunk lid 1 is slow, an upper section of the cushioning section 30 shown in FIG. 7(a) is first collapsed, whereupon the nonlinear flexible member 28 starts being subjected to load. When the load applied to the nonlinear flexible member 28 has been increased to a predetermined value or greater by the pressure on the pressure sensor 2 by the pinched object, the nonlinear flexible member 28 of the area having undergone pressure abruptly deforms from convex to concave as shown in FIG. 7(b), whereby the piezoelectric sensor adjacently disposed thereto is also simultaneously deflected and abruptly deformed, to thus output a large output signal. As a result, the determination means can determine occurrence of pinching, thereby achieving further-enhanced reliability of pinching detection.

### Third Embodiment

An invention of a third embodiment will be described hereunder. A difference between the third embodiment and the first and second embodiments lies in that the object maintains contact with the pressure sensor 2 in accordance with a signal output from the piezoelectric sensor 8.

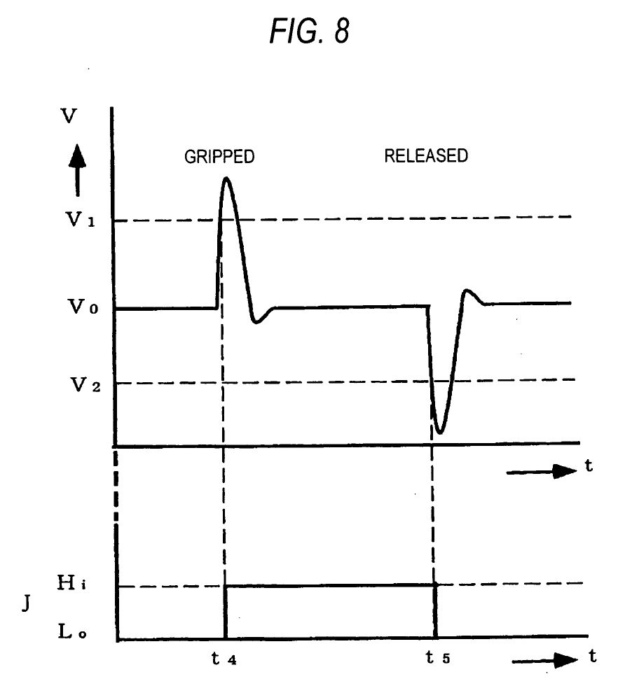

The operation stemming from the above-described configuration is described by reference to FIG. 8. FIG. 8 is a characteristic view showing a signal V output from a filter section 19 in determination means 16 of the third embodiment and a determination J output from a pinch determination section 20 of the same. In FIG. 6, V and J denote, in this order, vertical axes, and a horizontal axis represents a time “t.” The filter section 19 employs a configuration analogous to those of the first and second embodiments.

As shown in FIG. 8, when a portion of the pressure sensor 2 of the trunk lid 1 is gripped or released by a hand, a signal component greater than a reference potential V0 and a signal component smaller than the same appear in the voltage V at a moment (time t4) when the portion is gripped and another moment (time t5) when the gripped portion is released. When the piezoelectric sensor 8 has already become deformed while remaining in a gripped state (time t4 to time 5), no signal appears. Consequently, in the case of the procedures for determining occurrence of pinching according to the first embodiment, when the trunk lid 1 is closed while a portion of the pressure sensor 2 is gripped by a hand, the hand may still remain pinched even when pinching has arisen, so long as the piezoelectric sensor 8 has already been deformed.

As shown in FIG. 8, in the third embodiment, when V has come to V1 or more at time t4, the pinch determination section 20 brings J to a Hi level on the assumption that the object maintains contact with the pressure sensor until V comes to V2 or less. When V has dropped to V2 or less, the pinch determination section brings J to a Lo level on the assumption that the object is released from contact with the pressure sensor. When J is at the Hi level, the control means 25 prohibits closing action of the drive means 24 and provides the display section 26 with a display indicating that the object maintains contact with the pressure sensor 2.

By means of the above-described operation, the determination means determines whether or not the object maintains contact with the pressure sensor in accordance with the signal output from the piezoelectric sensor. For instance, when the object is determined to maintain contact with the pressure sensor, control for prohibiting closing of the trunk lid becomes possible, whereby enhanced reliability is attained.

### Fourth Embodiment

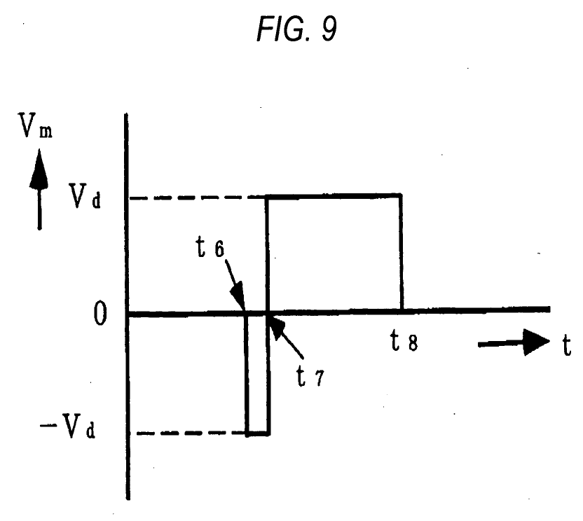

An opening/closing apparatus according to an invention of a fourth embodiment will be described hereunder. In the fourth embodiment, the apparatus has a configuration for controlling the drive means 24 such that the trunk lid 1 is closed after having been moved over a predetermined distance in an opening direction by the control means 25. Specific procedures will be described by reference to FIG. 9. FIG. 9 is a characteristic view showing a voltage Vm applied to the drive means 24. In the drawing, the vertical axis is denoted by Vm, and the horizontal axis is denoted by time “t.” In FIG. 9, when a close switch for commanding closing action is activated at time t6 at the time of closing of the trunk lid 1, the trunk lid 1 is moved in an opening direction while the voltage applied to the drive means 24 is held at −Vd until time t7. After time t7, Vm is held at +Vd until time t8, thereby closing the trunk lid 1. The essential requirement is to optimize setting of the time from time t6 to time t7 in view of the weight of the trunk lid 1, the capability of the drive means 24, or the like. However, the time may be on the order of a minimum of hundreds milliseconds.

In the first embodiment, when the object has contacted the pressure sensor 2 before starting of closing action of the trunk lid 1, there may arise a case where the piezoelectric sensor 8 is not subjected to sufficient deformation even after the trunk lid 1 has started closing action, which in turn results in a failure to determine occurrence of pinching. However, according to the above-described configuration, the trunk lid 1 is closed after having once been moved over a predetermined distance in the opening direction. The inertial force of the object having moved in the opening direction is applied to the pressure sensor 2 by means of the closing action, which in turn adds to the pressure exerted on the pressure sensor 2. As a result, the piezoelectric sensor 8 is subjected to sufficient deformation, so that occurrence of pinch can be detected without fail.

When the trunk lid 1 is closed from a fully-opened state by means of the configuration, there may also be employed a configuration for stopping closing operation after the closing operation has been [performed for a given period of time and closing the trunk lid 1 after the trunk lid has once moved over a predetermined distance in the opening direction.

### INDUSTRIAL APPLICABILITY

As is evident from the above-described embodiments, the present invention yields an advantage of the ability to detect pinching by a trunk lid, because the pressure sensor is disposed in a flexible manner along the geometry of the trunk lid. The pressure sensor has a flexible piezoelectric sensor, and the sensor is not a contact-type pressure sensitive switch but a non-contact-type sensor. Therefore, even when the sensor is disposed along a bent section, there is yielded an advantage of the ability to detect occurrence of pinching without involvement of occurrence of a detection error and achieve improved reliability.

The pressure sensor has a nonlinear flexible member whose displacement in response to load is nonlinear. The piezoelectric sensor is disposed adjacent to the nonlinear flexible member. For instance, even when an object is pinched when the closing speed of the trunk lid is slow, the nonlinear flexible member is quickly deformed as a result of the pressing load exerted on the pressure sensor by the object having reached a predetermined value or more, and the adjacently-disposed piezoelectric sensors also undergo sudden deformation, thereby outputting a large output signal. As a result, occurrence of pinching can be determined by the determination means, and reliability concerning detection of pinching is greatly enhanced.

The determination means determines whether or not the object maintains contact with the object, on the basis of the signal output from the piezoelectric sensor. For instance, when the object is determined to maintain contact with the piezoelectric sensor, control for inhibiting closing of the trunk lid becomes feasible, resulting in enhanced reliability.

The pressure sensor has a cushioning section which can be compressed by pressing action stemming from the pinched object. Even when occurrence of pinching has been detected, the cushioning section is compressed until movement of the trunk lid is reversely moved. Therefore, there is an advantage of the ability to suppress an increase in pinching load applied to the object, thereby diminishing stress or damage inflicted on the pinched object.

Moreover, the present invention further comprises the above-described pinching detection apparatus, drive means for driving the trunk lid, and control means for controlling the drive means so as to release pinching when pinching is determined to have arisen on the basis of the signal output from the determination means. There is an advantage of the ability to prevent occurrence of unwanted pinching, because pinching is released when pinching is determined to have arisen.

When the trunk lid is closed, the drive means is controlled to close the trunk lid after the trunk lid has once been moved over a predetermined distance in an opening direction. Even when the object has come into contact with the piezoelectric sensor before the trunk lid starts closing, the trunk lid is closed after having once been moved over a predetermined distance in an opening direction, so that the inertial force of the object having moved in the opening direction is applied to the piezoelectric sensor by means of the closing action. As a result, the piezoelectric sensor is reliably pressed, and, therefore, there is an advantage of the ability to reliably detect occurrence of pinching.

1. A pinching detection apparatus comprising:
a pressure sensor disposed along an outer edge of a trunk lid of a vehicle; and
determination means for detecting that an object is pinched between a body opening section of said vehicle and said trunk lid in accordance with a signal output from said pressure sensor.

2. The pinching detection apparatus according to claim 1, wherein said pressure sensor has a flexible piezoelectric sensor.

3. The pinching detection apparatus according to claim 2, wherein said pressure sensor has a nonlinear flexible member whose displacement in response to load is nonlinear, and said piezoelectric sensor is disposed adjacent to said nonlinear flexible member.

4. The pinching detection apparatus according to claim 2, wherein said determination means determines whether or not said object maintains contact with the object, on the basis of said signal output from said piezoelectric sensor.

5. The pinching detection apparatus according to claim 1, wherein said pressure sensor has a cushioning section which can be compressed by pressing action stemming from pinching of said pinched object.

6. An opening/closing apparatus comprising:
a pinching detection apparatus having a pressure sensor laid along an outer edge of a trunk lid of a vehicle, and determination means for detecting that an object is pinched between a body opening section of said vehicle and said trunk lid in accordance with a signal output from said pressure sensor;
drive means for driving said trunk lid; and
control means for controlling said drive means so as to release pinching when occurrence of pinching has been determined by said pinch determination means on the basis of a signal output from said determination means.

7. The opening/closing apparatus according to claim 6, wherein, when closing said trunk lid, said control means controls said drive means so as to close said trunk lid after said trunk lid has once been moved over a predetermined distance in an opening direction.
